(19) United States
(12) Patent Application Publication
(10) Pub. No.: US 2010/0012093 A1
(43) Pub. Date: Jan. 21, 2010

(54) High-pressure fuel injector to fuel rail connection

(76) Inventors: Dean M. Pepperine, Remsen, NY (US); Robert B. Perry, Leicester, NY (US); Jason M. Urckfitz, Mendon, NY (US); Kirk W. Caloroso, Rochester, NY (US)

Correspondence Address: Delphi Technologies, Inc., M/C 480-410-202, PO BOX 5052, Troy, MI, 48007, US

(21) Appl. No.: 12/218,833

(22) Filed: Jul. 18, 2008

(51) Int. Cl. F02M 61/14; F16L 23/00

(52) U.S. Cl. 123/470; 123/456; 285/407

(57) ABSTRACT

A coupling for suspending a fuel injector from a fuel rail assembly of an internal combustion engine includes a collar that mates with the fuel injector and a retainer clip that engages with the collar and with an annular flange of an injector socket thereby mechanically connecting the fuel injector to the fuel rail assembly. The retainer clip includes windows having a convex profile to enable even load distribution upon the socket flange when assembled. Coincident keyed features are integrated in the flange of the injector socket and in the collar to facilitate correct alignment of the injector relative to the fuel rail. Paired together, the retainer clip and the collar enable a secure, and coincident keyed fuel injector-to-fuel rail connection that is able to withstand high pressure separating loads.

### TECHNICAL FIELD

The present invention relates to fuel injection systems of internal combustion engines; more particularly to fuel rail assemblies for supplying highly pressurized fuel to fuel injectors for direct injection into engine cylinders; and most particularly, to an apparatus and method for coupling a fuel injector for gasoline direct injection to a fuel rail.

### BACKGROUND OF THE INVENTION

Fuel rails for supplying fuel to fuel injectors of internal combustion engines are well known. A fuel rail assembly, also referred to herein simply as a fuel rail, is essentially an elongated tubular fuel manifold connected at an inlet end to a fuel supply system and having a plurality of ports for mating in any of various arrangements with a plurality of fuel injectors to be supplied. Typically, a fuel rail assembly includes a plurality of fuel injector sockets in communication with a manifold supply tube, the injectors being inserted into the sockets.

Fuel injection arrangements may be divided generally into multi-port fuel injection (MPFI), wherein fuel is injected into a runner of an air intake manifold ahead of a cylinder intake valve, and direct injection (DI), wherein fuel is injected directly into the combustion chamber of an engine cylinder, typically during or at the end of the compression stroke of the piston.

A DI fuel rail assembly must sustain significantly higher fuel pressures than a MPFI fuel rail assembly to assure proper injection of fuel into a cylinder having a compressed charge during the compression stroke.

Typical, DI fuel systems employ fuel injectors that are mechanically supported on the engine's cylinder head and are, therefore, referred to as non-hanging injectors. An MPFI fuel system, on the otherhand, employs injectors that are mechanically coupled to both the fuel rail and the cylinder head. Current DI technology developments may include a hanging injector system that suspends injectors from the fuel rail via a mechanical coupling, to eliminate metal-to-metal contact between the injector and the cylinder head. Such hanging injectors are highly desirable, whether in a DI or MPFI system, to reduce engine generated noise.

What is needed in the art is a fuel injector to fuel rail connection that is able to mechanically support loads originating from relatively high fuel pressures and from combustion pressure of direct injection fuel injection systems.

It is a principal object of the present invention to provide a high-pressure fuel injector coupling that easily connects a DI fuel injector to a fuel rail and that is able to manage relatively high separating loads between the fuel rail and the fuel injector due to relatively high DI fuel pressure levels.

### SUMMARY OF THE INVENTION

Briefly described, a fuel injector coupling includes a retainer clip and a collar, which, when paired together, enable a simple, secure, and coincident keyed fuel injector-to-fuel rail connection that is able to withstand separating loads originating from the relatively high fuel pressure of a direct injection fuel system of an internal combustion engine.

In one aspect of the invention, the shape of the retainer clip permits fuel injector retention to a fully-annular flange of an injector socket, which is highly desirable since an annular flange is easier to machine than other geometrical shapes. The retainer clip is further shaped to provide ease of assembly and disassembly. The retainer clip includes convex windows to target load distribution upon the socket flange and the collar when assembled.

In another aspect of the invention, anti-rotation and retention features for the collar are integrated into the over mold of the injector. Such anti-rotation features are preferably designed to retain the collar in position until fuel rail assembly.

In still another aspect of the invention, coincident keyed features are integrated in the flange of the injector socket and in the collar to facilitate correct alignment of the injector relative to the fuel rail.

### BRIEF DESCRIPTION OF THE DRAWINGS

The present invention will now be described, by way of example, with reference to the accompanying drawings, in which:

FIG. 1 is an exploded isometric view of a hanging injector fuel system, in accordance with the invention; and

FIG. 2 is an isometric view of the assembled hanging injector fuel system, in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

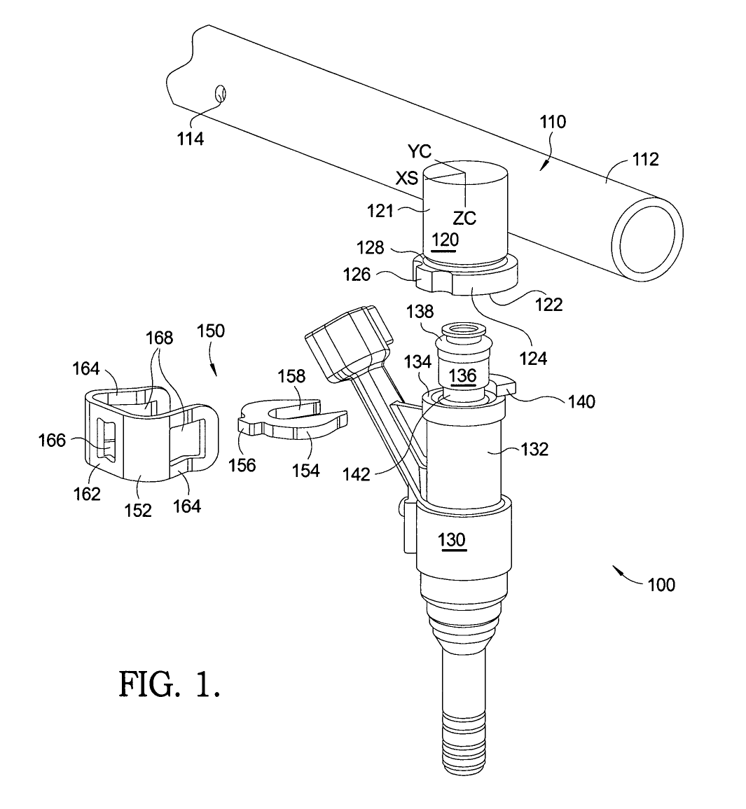

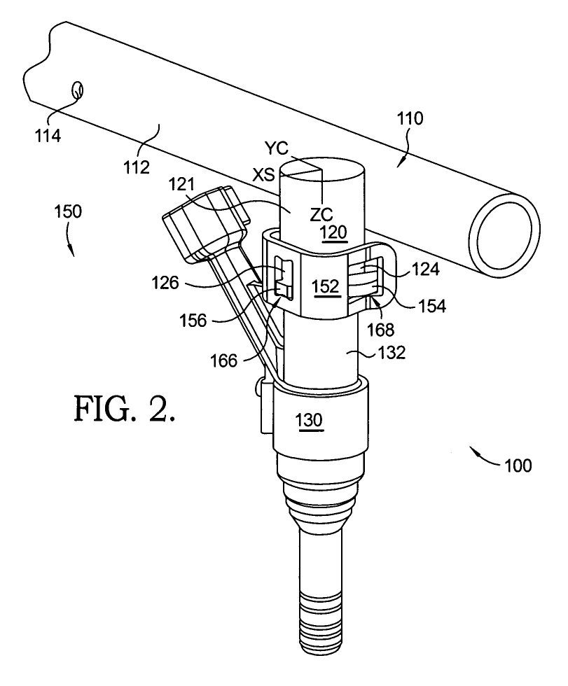

Referring to FIG. 1, a hanging injector fuel system 100 includes a fuel rail assembly 110, a fuel injector 130, and a coupling 150. Fuel rail assembly 110 includes a fuel distribution conduit 112 that may be, for example, an elongated tube as shown in FIG. 1 or may be a non-round conduit. At least one injector socket 120 is assembled to conduit 112 to be in fluid communication with the interior of conduit 112 via an opening 114, shown in FIGS. 1 and 2 before socket 120 is attached to conduit 112. Fuel rail assembly 110 is connected to a typical fuel supply system (not shown).

Injector socket 120 may include a cylindrical body 121 that is closed at one end and that is open at an opposite end 122 for receiving fuel injector 130. Accordingly, injector socket 120 may have, but is not limited to, the shape of a cup as shown in FIG. 1. Injector socket 120 includes a flange 124 that has preferably an annular shape and is positioned proximate to open end 122. A coincident keyed feature 126 may be integrated in flange 124 to facilitate correct alignment of fuel injector 130 relative to fuel distribution conduit 112. Coincident keyed feature 126 may be formed, for example, as a tab. Flange 124 is designed to be able to bear an axial load. Injector socket 120 includes a circumferential undercut feature 128 immediately above flange 124 to reduce tension within socket 124. Undercut feature 128 is positioned where flange 124 radially extends from socket body 121.

Fuel injector 130 includes an overmold 132 surrounding a fuel tube 136. Overmold 132 is positioned such that a fuel inlet section 138 of fuel tube 136 extends beyond an upper end 134 of overmold 132 for assembly into injector socket 120. Fuel tube 136 includes a circumferential groove 142 that is positioned adjacent to the upper end 134 of overmold 132 when assembled. An anti-rotation feature 140 is integrated into overmold 132 and extends upper end 134 axially. Anti-rotation feature 140 may further extend the general outer circumference of overmold 132 radially. Anti-rotation feature 140 is preferably axially aligned with groove 142 of fuel tube 136 for mating with coupling 150. While fuel injector 130 is illustrated as a fuel injector for gasoline direct injection, it may be replaced by any other type fuel injector.

Coupling 150 includes a retainer clip 152 and a collar 154. Retainer clip 152 paired with collar 154 enable mechanical retention of fuel injector 130 to socket 120 even under relatively high separating loads. No additional support, for example, by the cylinder head of the internal combustion engine is needed. Accordingly, fuel injector 130 is suspended from fuel rail assembly 110 via mechanical coupling 150 such that no hard, metal-to metal contact need to exist between fuel injector 130 and the cylinder head. Retainer clip 152 may be shaped as a C-clip that partially encloses flange 124 and collar 154 and that engages with a circumferential contour of flange 124 and collar 154 when assembled.

Collar 154 has a generally circular shape and includes a coincident keyed feature 156 that is indexed to slot 158. Keyed feature 158 may be radially aligned with a slot 158. Coincident keyed feature 156 may extend outwards from the outer circumferential contour of collar 154 and may be formed, for example, as a tab. Slot 158 extends into collar 154 from the circumferential contour such that slot 158 is open at the circumferential contour of collar 154. Collar 154 is assembled to fuel injector 130 such that slot 158 mates with groove 142 integrated into fuel tube 138 and anti-rotation feature 140 integrated into overmold 132. Collar 154 may be pre-assembled to fuel injector 130 prior to shipping and prior to assembly of fuel injector 130 to fuel rail assembly 110. Collar 154 may be held in place by anti-rotation feature 140 integral with overmold 132, for example by an interference fit.

Retainer clip 152 includes a generally straight or slightly bent center section 162 and two end sections 164 curving away from center section 162 at opposite sides; all three sections forming a c-shaped cross-section. Center section 162 includes a window 166 designed for receiving coincident keyed features 128 and 156 of flange 124 and of collar 154, respectively. Each of the two end sections 164 includes a window 168 for receiving flange 124 of injector socket 120. In one aspect of the invention, at least the upper and the lower side of each of the windows 166 and 168 is curved to target even load distribution upon the load bearing socket flange 124 when assembled. A curved shape of windows 166 and 168 without sharp corners enables an improved management of loads, for example, by avoiding point loads. The sides, all four or at least the upper and the lower side, of each of the windows 166 and 168 have preferably a convex shape to distribute loads originating from separation forces acting between fuel injector 130 and fuel rail assembly 110 due to high operating fuel pressures. The distant tip of each end section 164 may be formed to curve radially outwards for ease of assembly and disassembly.

Retainer clip 152 and collar 154 may be stamped sheet metal parts and may be formed from a non-resilient cold-formable material that may be plated for corrosion protection. For example, a high carbon-steel with zinc-nickel plating applied may be used.

Referring to FIG. 2, hanging injector fuel system 100 is illustrated fully assembled. Retainer clip 152 is installed by being pushed in a radial direction over flange 124 of injector socket 120 and over collar 154 previously assembled as described above to fuel injector 130. Due to the ability of retainer clip 152 to elastically deform, both end sections 164 are pushed outwards during the movement in radial direction and snap back once the outer circumferential contour of flange 124 and of collar 154 mate with windows 168. As can be seen in FIG. 2, the outer circumferential contours of flange 124 and of collar 154 partially extend into windows 168, and end sections 164 of retainer clip 152 rest against the outer circumferential contour of body 121 of injector socket 120 above flange 124. Coincident keyed features 128 and 156 of flange 124 and of collar 154, respectively, are received by window 162 of retainer clip 152 thereby ensuring proper alignment of fuel injector 130 relative to conduit 112. By engaging slot 158 of collar 154 with anti-rotation feature 130 integral with overmold 132 of fuel injector 130 on one side and by receiving coincident keyed feature 156 of collar 154, rotation of fuel injector 130 relative to conduit 112 is prevented. When fuel injector 130 is assembled within injector socket 120 and when retainer clip 152 is installed over flange 124 and collar 154, flange 124 is in contact with collar 154.

As can be seen in FIG. 2, one coupling 150 is needed per fuel injector 130. Accordingly, coupling 150 may be utilized in an internal combustion engine employing two, four, six, eight, or any other number of cylinders.

By providing coupling 150, relatively high fuel pressure loads causing separating forces between fuel rail assembly 110 and fuel injector 130 can be managed and a hanging fuel injector system 100 can be realized, where metallic contact between fuel injector 130 and a cylinder head is avoided. By minimizing a hard metal-to metal contact between the fuel injector and engine, operational noise and wear are reduced.

While coupling 150 may be especially useful for applications in fuel injection systems for direct injection, applications in fuel injection systems for port injection may be possible.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A coupling for suspending a fuel injector from a fuel rail assembly of an internal combustion engine, comprising:
a collar including a slot and a coincident keyed feature indexed to said slot, wherein said slot mates with said fuel injector, and wherein said coincident keyed feature assists alignment of said fuel injector to said fuel rail; and
a retainer clip including a plurality of windows having curved profiles, wherein said windows engage with said collar and with said fuel rail assembly thereby mechanically connecting said fuel injector to said fuel rail assembly.

2. The coupling of claim 1 wherein said retainer clip has a C-shaped cross-section.

3. The coupling of claim 1 wherein said keyed feature is radially aligned with said slot.

4. The coupling of claim 1, wherein said collar has a generally circular shape, wherein said slot extends into said collar from a circumferential contour of said collar, and wherein said slot is open at said circumferential contour.

5. The coupling of claim 1, wherein said coincident keyed feature extends outwards from a circumferential contour of said collar.

6. The coupling of claim 1, wherein said slot mates with a circumferential groove integrated into a fuel tube of said fuel injector.

7. The coupling of claim 1, wherein said slot mates with an anti-rotation feature integrated into an overmold of said fuel injector.

8. The coupling of claim 7, wherein said anti-rotation feature is interference fitted with said collar.

9. The coupling of claim 1, wherein said retainer clip includes a center section and two end sections curving away from said center section at opposite sides.

10. The coupling of claim 9, wherein said center section includes a first window that receives said coincident keyed feature of said collar and a coincident keyed feature of said'fuel rail assembly.

11. The coupling of claim 9, wherein each of said two end sections includes a second window that engages with said collar and said fuel rail assembly.

12. The coupling of claim 1, wherein said windows have a convex shaped profile.

13. The coupling of claim 1, wherein said fuel injector is a fuel injector for direct injection of fuel into a cylinder of said internal combustion engine.

14. A hanging injector fuel system for an internal combustion engine, comprising:
an injector socket including an annular flange having a coincident keyed feature;
a fuel injector including a fuel tube and an overmold; and
a mechanical coupling including a collar having a coincident keyed feature and a retainer clip having a first window and a second window;
wherein said collar mates with said fuel tube and said overmold;
wherein said first window receives said coincident keyed features of said injector socket and of said collar; and
wherein said second window mates with a circumferential contour of said flange and said collar.

15. The hanging injector fuel system of claim 14, wherein said first and second windows have a curved profile.

16. The hanging injector fuel system of claim 12, wherein said tube includes a circumferential groove, wherein said overmold includes an anti-rotation feature axially aligned with said groove, wherein said collar includes a slot indexed to said coincident keyed feature, wherein said slot mates with said groove and said anti-rotation feature, and wherein said anti-rotation features holds said collar in place by an interference fit.

17. The hanging injector fuel system of claim 14, wherein said injector socket includes a generally cylindrical body that has an open end and an opposite closed end, wherein said flange radially extends from said body proximate to said open end; and wherein a circumferential undercut feature is positioned where said flange extends from said body.

18. The hanging injector fuel system of claim 14, wherein said retainer clip is in contact with said injector socket above said flange.

19. The hanging injector fuel system of claim 14, wherein distant tips of said retainer clip curve radially outwards.

20. A method for connecting a direct injection fuel injector to a fuel rail assembly, comprising the steps of:
pre-assembling a collar to said fuel injector;
assembling said fuel injector with said collar to an injector socket of said fuel rail assembly such that said collar contacts said injector socket; and
mechanically coupling said fuel injector to said injector socket by placing a retainer clip around said collar and around said injector socket.

21. The method of claim 20, further including the steps of:
integrating a coincident keyed feature into an annular flange of said injector socket;
integrating a coincident keyed feature into said collar;
receiving said coincident keyed features of said injector socket and of said collar with a window integrated into a center section of said retainer clip; and
indexing said fuel injector relative to said fuel rail assembly.

22. The method of claim 20, further including the steps of:
forming a window in each of two side sections that curve away from a center section of said retainer clip; and
mating said collar and said flange with said windows.
